(19) United States
(12) Patent Application Publication
(10) Pub. No.: US 2017/0177891 A1
(43) Pub. Date: Jun. 22, 2017

(54) SYSTEMS AND METHODS OF SELECTION AND APPROVAL OF MEDIA CONTENT AND APPLICATIONS

(71) Applicant: Google Inc., Mountain View, CA (US)

(72) Inventors: Courtney Hampson, Sunnyvale, CA (US); Jason Robert Richard Sanio, Sunnyvale, CA (US)

(21) Appl. No.: 14/977,939

(22) Filed: Dec. 22, 2015

(51) Int. Cl. G06F 21/62

(52) U.S. Cl. CPC G06F 21/6218

(57) ABSTRACT

Systems and methods of setting restrictions and pre-approval of selected at least one of a media content and an application are provided that include linking a child account to a parent account, where the parent account includes payment information, setting, a risk tolerance for at least one of a media content and an application selected via the child account, receiving a selection for at least one of a media content and an application via the child account, identifying a risk basis value of the selected at least one of the media content and the application for the child account, and approving the selected at least one of the media content and the application for the child account when the identified risk basis value of the at least one of the media content and the application is equal to or less than the set risk tolerance.

### BACKGROUND

Presently, applications for mobile, tablet, and other computing devices provide parental monitoring features to allow parents to decide how much screen time a child can have (e.g., the amount of time the child spends using the mobile, tablet, or other computing device). These applications may restrict the access of a child to a particular number of hours per day, or a particular period of time during the day (e.g., from 3PM to 8 PM). Other applications restrict the child from viewing or downloading a particular type of content, such are adult content.

Other presently-available applications for mobile, tablet, or other computing devices allow a parent to set an allowance (e.g., an amount of money that can be used for purchases of media or applications). Other applications allow a parent to restrict marketplace access for a child.

### BRIEF SUMMARY

Systems and methods of the disclosed subject matter provide for establishing media content and/or application selection accounts for a child account for a device, and linking the child account with a parent account having payment information. A parent and/or guardian, via the parent account, may set parameters for approving or declining media content and/or application requests received from a child account. The selected media content may include audio items, video items, applications, books, articles, or the like for download, viewing, and/or purchase. In embodiments of the disclosed subject matter, settings may be selected so as to auto-approve or auto-decline media content and/or applications selections made by a child account, and/or allow the parent account to actively approve the media content and/or application selections. The embodiments of the disclosed subject matter may also allow a parent to select options in a parent account to set an allowance for an associated child account, and may allow the parent to selection options which may control the type of media content and/or applications the allowance amount is being spent on by the child via the child account.

According to an embodiment of the disclosed subject matter, a method is provided that includes linking, at a memory device of a server, a child account to a parent account, where the parent account includes payment information, setting, at the memory device of the server via the parent account, a risk tolerance for at least one of a media content and an application selected via the child account, receiving a selection, at the server, for at least one of a media content and an application via the child account, identifying, at the server, a risk basis value of the selected at least one of the media content and the application for the child account, approving, at the server, the selected at least one of media content and the application for the child account when the identified risk basis value of the at least one of the media content and the application is equal to or less than the set risk tolerance, notifying, at the server, the parent account of the received selection of the at least one of the media content and the application from the child account, and transmitting, from the server, the approved selected at least one of the media content and the application to a device associated with the child account.

According to an embodiment of the disclosed subject matter, a system is provided that includes a first device that is associated with a child account, a second device that is associated with a parent account, where the parent account includes payment information, and a server to link the child account to the parent account in a memory device of the server, set a risk tolerance in the memory device of the server for at least one of a media content and an application selected via the child account according to input received from the parent account of the second device, to receive a selection for at least one of the media content and the application via the child account, identify a risk basis value of the selected at least one of the media content and the application for the child account, approve the selected at least one of the media content and the application for the child account when the identified risk basis value of the at least one of the media content and application is equal to or less than the set risk tolerance, notify the parent account of the received selection of at least one of the media content and the application from the child account, and transmit the approved selected at least one of the media content and the application to the first device.

According to an embodiment of the disclosed subject matter, means for selecting and approving at least one of a media content and an application are provided that include linking, at a memory device of a server, a child account to a parent account, where the parent account includes payment information, setting, at the memory device of the server via the parent account, a risk tolerance for at least one of a media content and an application selected via the child account, receiving a selection, at the server, for at least one of a media content and an application via the child account, identifying, at the server, a risk basis value of the selected at least one of the media content and the application for the child account, approving, at the server, the selected at least one of the media content and the application for the child account when the identified risk basis value of the media content and the application is equal to or less than the set risk tolerance, notifying, at the server, the parent account of the received selection of the at least one of the media content and the application from the child account, and transmitting, from the server, the approved selected at least one of the media content and the application to a device associated with the child account.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a method of processing requests for content that is selected via a user interface of a child account, where the child account that is linked to a parent account according to an embodiment of the disclosed subject matter.

FIG. 2 shows a display screen of a device associated with a parent account that can receive a selection of a risk tolerance for media content and/or an application selected via the child account according to an embodiment of the disclosed subject matter.

FIG. 3 shows a display screen of a device associated with a child account to receive a selection of media content and/or an application according to an embodiment of the disclosed subject matter.

FIG. 4A shows a display screen of the device associated with the parent account to notify the parent account of media content and/or an application selection received via the child account according to an embodiment of the disclosed subject matter.

FIG. 4B shows a display screen of the device associated with the child account to provide a notification of approval of the media content and/or an application selection according to an embodiment of the disclosed subject matter.

FIG. 5 shows a computing device according to an embodiment of the disclosed subject matter.

FIG. 6 shows a network configuration according to an embodiment of the disclosed subject matter.

FIG. 7 shows an example network and system configuration according to an embodiment of the disclosed subject matter.

### DETAILED DESCRIPTION

Embodiments of the disclosed subject matter provide application-based, service-based, and/or device-based accounts that allow a child-based account to be tied to an account of a parent and/or guardian. The child account may have a link to payment information of the associated parent account, such that purchases of media content and/or applications may be made with a parent's payment information. The parent account may receive one or more selections by a parent to approve or deny each request for new content made by an associated child account.

In embodiments of the disclosed subject matter, a child account may be created that may not be capable of making payments in connection with a request to purchase, download, and/or view content. The child account may be linked to a parent account (e.g., an account of a parent and/or guardian of the child who is associated with the child account). In some embodiments, account settings may be on a per-child basis. That is, different settings may be made for different children who may be different ages.

The parent, via selecting one or more options in the parent account, may control settings as to how and/or when the child account may make content purchases using the parent's payment information. The parent may also control settings to approve or decline a child's requests to view and/or download media content and/or an application selected by an associated child account. When a child makes a request to purchase, download, and/or view the media content and/or the application, the parent receives a notification message (e.g., via a parent application).

Embodiments of the disclosed subject matter may approve requests to purchase, download, and/or view digital content according to one or more settings in an account (e.g., in either the child account that is linked to a parent account, or in the parent account). The settings may be selected to approve or deny content requested by a child according to at least one of content type, content rating, educational value of the content, frequency of requests/purchases, cost of requests/purchases, genre of application, intent of an application, and/or percentage of allowance spent. The embodiments of the disclosed subject matter may receive selections in a parent account to set an allowance for an associated child account, and may receive one or more selections to set the type of media content and/or application the allowance amount may be spent on by a child via the child account.

Embodiments of the disclosed subject matter provide applications with selectable settings to increase the rate at which transactions for purchases, media content, and/or application requests may be approved. The embodiments of the disclosed subject matter provide access to paid and/or unpaid content more rapidly, and minimize delay in children being able to access educational and/or entertaining content that meets the content guidelines and/or criteria established by a parent and/or guardian.

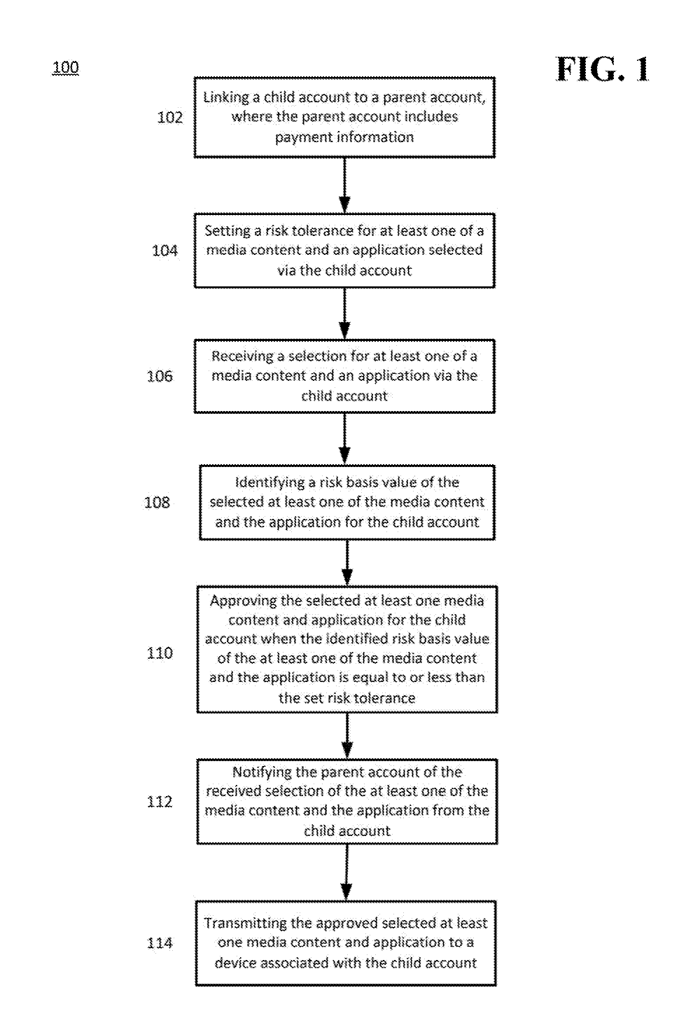

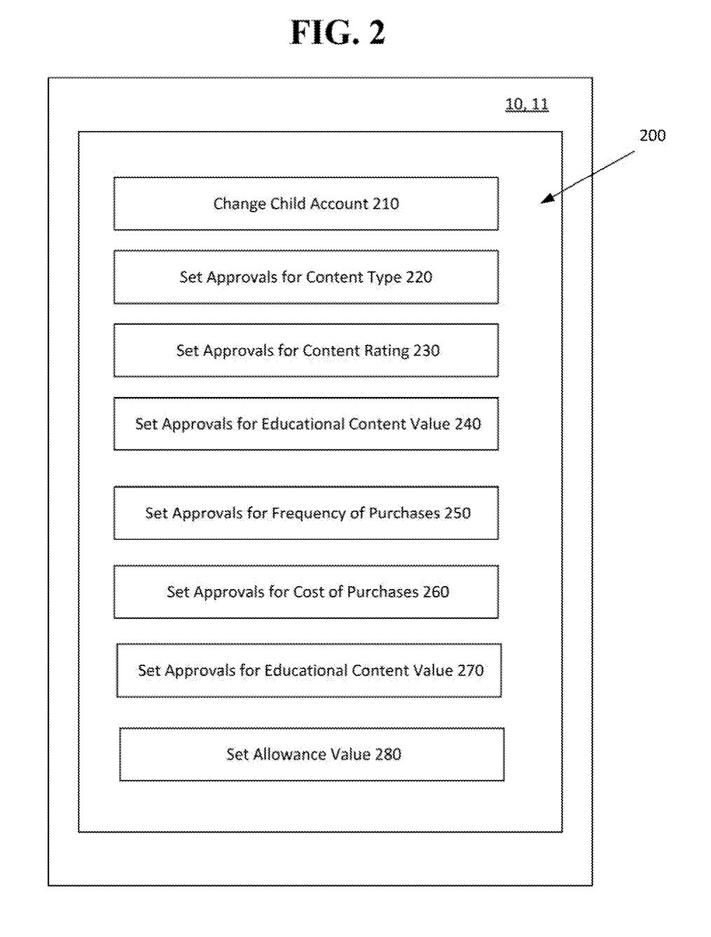

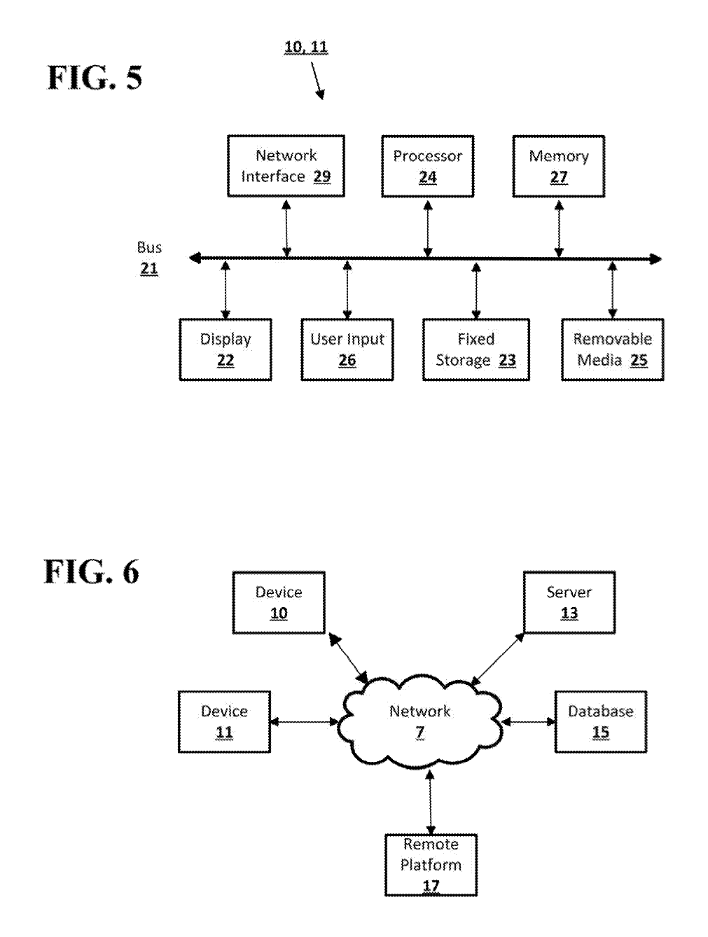

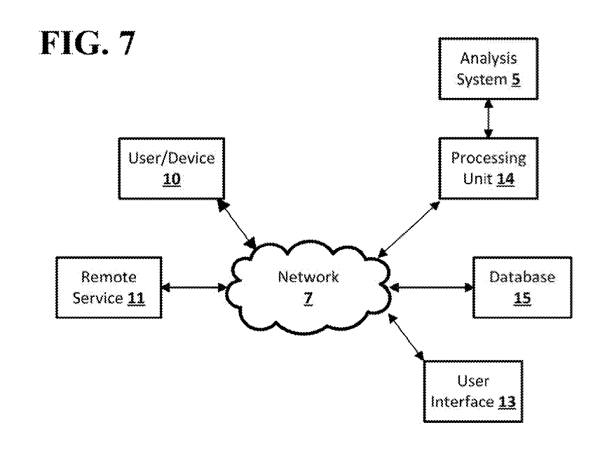

FIG. 1 shows a method 100 of processing requests for content selected by a child account that is linked to a parent account according to an embodiment of the disclosed subject matter. At operation 102, a server (e.g., server 13 and/or remote platform 17 shown in FIG. 6, and/or processing unit 14 and/or analysis system 5 shown in FIG. 7, and discussed in detail below), may link a child account to a parent account in a memory device of the server, where the parent account includes payment information. Payment information may include, for example, bank account information, credit card information, debit account information, and/or any other suitable payment account information. A device may be a smart phone, smart watch, tablet, wearable computing device, or the like, such as device 10, 11 shown in detail in FIG. 5 and discussed below, as well as shown in FIGS. 2-4, 6, and 7 and discussed below. In some embodiments, the child account may be associated with a first device, and the parent account may be associated with a second device. In some embodiments, a single device may be linked to both the parent account and the child account.

A parent account may be created so as to include payment information, and may be registered with the server, and a child account may be subsequently created and linked to the parent account. The parent account may be an account of a parent and/or guardian (e.g., legal guardian, teacher, school administrator, or the like). One of more child accounts can be associated with a parent account. For example, a parent may have children with different ages, and each of the child accounts may be associated with the parent account. In some embodiments, risk tolerances may be independently set for each of the child accounts associated with the parent account, as discussed in detail below. Alternatively, settings for risk tolerance can be set and applied to all of and/or a select number of the child accounts.

A risk tolerance may be set, for example, in a memory device of the server (e.g., server 13 shown in FIG. 6, and/or remote service 11 and/or processing unit 14 shown in FIG. 7), for media content and/or an application selected via the child account at operation 104. In some embodiments, such as those discussed below in connection with FIG. 2, a risk tolerance may be set according to a content type. FIG. 2 shows a device 10, 11, which is discussed in detail below in connection with FIGS. 5-7, which may be associated with a parent account and may include a user interface 200 to receive selections from a parent user. Selections received via the user interface 200 may be provided to the server, and associated with the parent account and/or one or more child accounts.

The user interface 200 shown in FIG. 2 may include options 210, 220, 230, 240, 250, 260, 270, and 280, which may be selected by a user. The selection of one or more of these options may display another user interface (not shown), in which a user may change an account, set approvals, set allowances, adjust settings and/or values, or the like. The user interface 200 shown in FIG. 2 may receive a selection of option 210 from a parent to change a child account (e.g., if there are a plurality of child accounts associated with the parent account). Upon selection of the child account via option 210, the parent may set approvals for the selected child account via the user interface 200, as discussed below.

The user interface 200 may receive a selection of option 220 to set approval for a content type. For example, a selected media content and/or an application may be a book that is rated as educational may have a lower risk score than non-educational books (e.g., comic books). In another example, the selected media content and/or an application that may be age appropriate for the child associated with the child account may have a lower risk score than media content and/or an application having an age range that is higher than that of the child of the child account. In yet another example, when the genre is a video game, the parent may select and/or set this type of content as being higher risk content.

In some embodiments, the risk tolerance may be set according to a content rating by selecting an option 230 to set approvals for content rating from the user interface 200. For example, by selecting option 230, the parent and/or guardian may allow purchases of media content and/or an application for kids aged 5-8, but no media content and/or an application for children who are 9 or older, if the child is 8 years old. The parent and/or guardian may also set a risk tolerance according to an educational value of the media content and/or application by selecting option 240 to set approvals for educational content value from the user interface 200. For example, by selecting option 240, the risk tolerance may be set according to whether the selected media content and/or application is a textbook, as opposed to a comic book.

In some embodiments, the risk tolerance may be set according to a set frequency of purchases by selecting option 250 to set approvals for frequency of purchase. For example, the risk tolerance may be adjusted to accept or decline back-to-back-to-back purchases of similar media content and/or an application. The risk tolerance may also be adjusted according to a cost of purchases by selecting option 260 to set approvals for cost of purchases with user interface 200. In some embodiments, the cost may be associated with the type of media content and/or application. For example, the risk tolerance may be adjusted to that $0.99 books may be auto-approved, but an in-application purchase for $100 of credit for a particular game would require parental approval.

In some embodiments, a risk tolerance may be set according to a genre or intent by selecting option 270 to set approvals for educational content value. For example, a risk tolerance may be set such that all applications (i.e., selected media content and/or application) that allow child to contact non-family members may be escalated to the parent (e.g., to be approved by the parent) for a child account of a child that is at or below a predetermined age (e.g., children under 13 years old).

In some embodiments, a risk tolerance may be set by selecting option 280 of user interface 200 to set a percentage of an allocated allowance for the child account with the set allowance value. For example, the risk tolerance may be set by the parent so that if a cost of a selected media content and/or an application is greater than a pre-determined percentage of the allowance, the selected media content and/or application is to be approved by the parent.

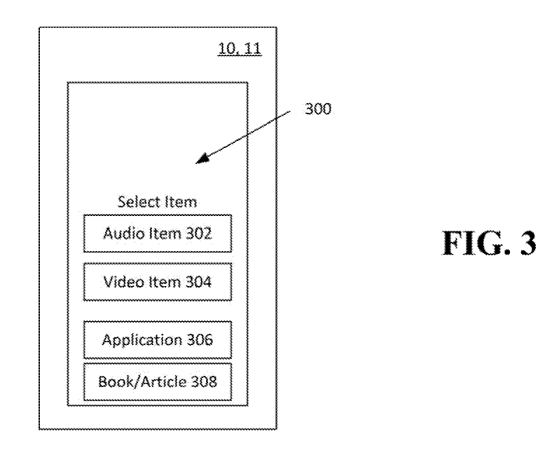

As shown in FIG. 1, a selection may be received, at the server, for media content and/or an application via the child account at operation 106. FIG. 3 shows a device 10, 11 which may include a user interface 300, which may be associated with the child account. Alternatively, in some embodiments, the device 10, 11 having user interface 300 may be associated with at least one of the child account and the parent account.

The user interface 300 may receive a selection (e.g., from a child) for media content and/or an application. For example, the user interface 300 may include media content and/or application selections for an audio item 302, a video item 304, an application 306, and/or a book or article 308. The audio item selection 302 may receive a request for media content for one or more songs, an album, an audio book, a podcast, or the like. The user interface 300 may receive a selection for the video item 304, which may be a request for a movie, television show, documentary, educational video, and/or any other suitable video content. The user interface 300 may receive a selection for the application 306, which may be a request for a software application for the device 10, 11. The user interface 300 may receive a selection for a book or article 308, which may be a request to download, view, and/or purchase a book, an article, and/or any other suitable text document.

When a request for media content and/or application has been made at operation 106 of FIG. 1, a risk basis value of the selected media content and/or application for the child account may be identified at the server at operation 108. According to the selection of the media content and/or application and the risk tolerance for media content and/or application that is set by the parent account as described above in connection with FIG. 2, the server may determine a risk basis value. In some embodiments, the risk basis value may be a numerical value that is determined by, for example, the server based on at least one of a rating, age range, media content type and/or application content type, and/or cost of the selected media content and/or application, and/or the child account initiating the request. For example, the server may determine the numerical value based on the rating, the age range, the media content type, and/or cost of the selected media content. The server may assign the determined numerical value to be the risk basis value, and the server may compare the risk basis value with a risk tolerance to determine whether to pre-approve the requested media item.

The risk basis value may determine whether the media content and/or application request from the child account may be auto-approved by the parent account (e.g., according to one or more settings received by the parent account), whether the request may need parental approval, and/or whether the media content and/or application request is auto-denied by the parent account. For example, when the risk basis value is equal to or less than the set risk tolerance, the selected media content and/or application may be auto-approved by the patent account. When the risk basis value is, for example, within a predetermined range that is greater than the set risk tolerance, the request for the media content and/or the application may need parental approval via the parent account. When the risk basis value is, for example, greater than the predetermined range that is greater than the set risk tolerance, the request for the media content and/or the application may be auto-denied by the parent account.

At operation 110, the selected media content and/or application for the child account may be approved, at the server, when the identified risk basis value of the media content and/or application is equal to or less than the set risk tolerance.

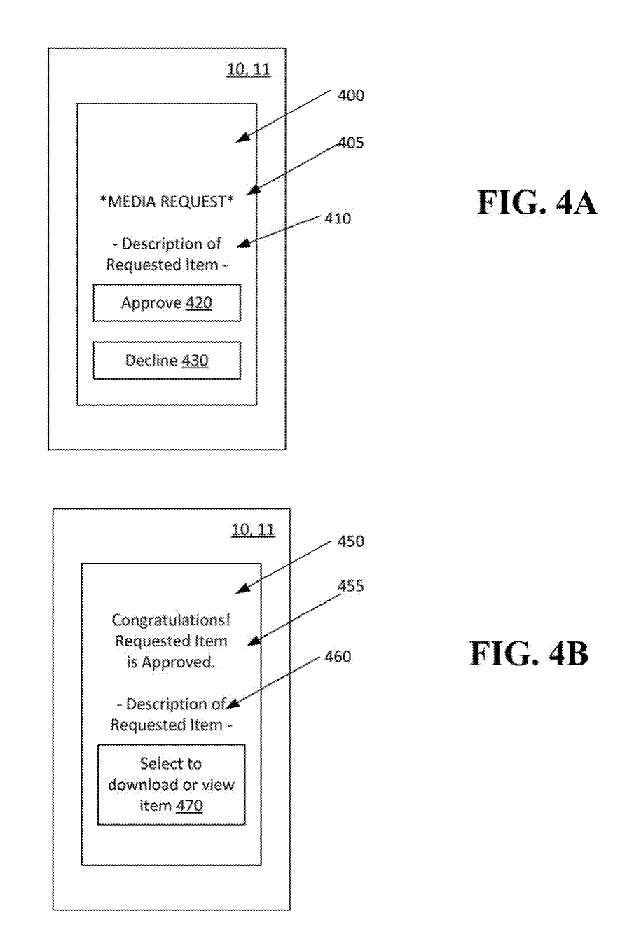

The parent account may be notified of the received selection of media content and/or an application from the child account at operation 112. FIG. 4A shows an example of a device 10, 11 associated with the parent account. The user interface 400 of the device 10, 11 may provide and/or display a notification 405 of a media content and/or an application request from a child account. In some embodiments, the notification may include identifying information for the child and/or child account associated with the request. For example, when there are a plurality of child accounts associated with a parent account, the notification 405 may provide identifying information of the child account making the media content and/or the application request. The user interface 400 may include a description 410 of the requested media content and/or application. For example, the description 410 may describe the audio item, video item, application, book, and/or article requested by the child account to download, purchase, and/or view. The information may include title, author, artist, rating (e.g., rating by other users and/or critics, level of adult content rating, etc.), length (e.g., number of pages, time length, etc.), educational content level (e.g., grade level), age range, cost, or the like. When the selected media content and/or application is not auto-approved by the parent account according to the approval settings received by user interface 200 of FIG. 2, the parent user of the parent account may select approve 420 or decline 430, to respectively approve or decline the requested media content and/or application request according to the description 410.

At operation 114 shown in FIG. 1, the approved selected media content and/or application may be transmitted from the server to a device associated with the child account. As shown in FIG. 4B, the device 10, 11 that may be associated with the child account may include a user interface 450, which may provide a notification 455 that the requested media content and/or application has been approved by the parent account. The user interface 450 may include a description 460 of the requested media content and/or applications that has been approved. The child user may select user interface item 470 to download, purchase, and/or view the approved media content and/or application.

In situations in which the systems discussed here collect personal information about users (e.g., in connection with the parent account and/or child account, discussed above), or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity (e.g., a child's identity) may be treated so that no personally identifiable information can be determined for the user, or a user's geographic location may be generalized where location information is obtained (such as to a city, ZIP code, or state level), so that a particular location of a user cannot be determined. In another example, the location of the device 10, 11 associated with the child account may be controlled so as the location cannot be determined. In some embodiments, the location of the device 10, 11 associated with the child account may only be available to the device 10, 11, associated with the parent account so that the parent is able to determine the location of their child. In the embodiments of the disclosed subject matter, the parent user of the parent account may have control over how information is collected and used about the parent user and the one or more child users.

Embodiments of the presently disclosed subject matter may be implemented in and used with a variety of component and network architectures. FIG. 5 is an example computing device 10, 11 suitable for implementing embodiments of the presently disclosed subject matter. The device 10, 11 may be, for example, a desktop or laptop computer, or a mobile computing device such as a smart phone, smart watch, tablet, wearable computing device, or the like. The device 10, 11 may be similar to and/or the same as devices 10, 11 shown in FIGS. 6-7 and described below. The device 10, 11 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the device 10, 11 are generally stored on and accessed via a computer readable medium, such as a hard disk drive (e.g., fixed storage 23), an optical drive, floppy disk, or other storage medium.

The fixed storage 23 may be integral with the device 10, 11 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth(R), near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an embodiment of the disclosed subject matter. One or more devices 10, 11, such as local computers, smart phones, tablet computing devices, and the like may connect to other devices via one or more networks 7.

Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The server 13 and/or the database 15 may provide requested media content and/or application that has been approved by a device 10, 11 associated with a parent account to a device 10, 11 associated with a child account. The server 13 and/or database 15 may store account information. For example, the server 13 and/or the database 15 may store parent account information, account information for one or more child accounts associated with the parent account, risk tolerance information and/or settings so pre-approve and/or pre-decline media content and/or application requests, or the like. The devices 10, 11 also may access remote platforms 17 or services provided by remote platforms 17 such as cloud computing arrangements and services. The remote platform 17 may include one or more servers 13 and/or databases 15.

FIG. 7 shows an example arrangement according to an embodiment of the disclosed subject matter. One or more devices or systems 10, 11, such as remote services or service providers 11, user devices 10 (e.g., devices associated with a child account and/or a parent account) such as local computers, smart phones, smart watches, wearable computing device, tablet computing devices, and the like, may connect to other devices via one or more networks 7. The remote service providers 11, may be, for example, providers of media content and/or applications, and/or may be services to assess the educational content of selected media content and/or application.

The network 7 may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15. For example, the machine learning system 5 may learn to determine the educational content of selected media content and/or application. In another example, the machine learning system 5 may learn to auto-approve or auto-decline requests for media content and/or application by a child account according to settings in the parent account.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
linking, at a memory device of a server, a child account to a parent account, wherein the parent account includes payment information;
setting, at the memory device of the server via the parent account, a risk tolerance for at least one of a media content and an application selected via the child account;
receiving a selection, at the server, for at least one of a media content and an application via the child account;
identifying, at the server, a risk basis value of the selected at least one of the media content and the application for the child account;
approving, at the server, the selected at least one of the media content and the application for the child account when the identified risk basis value of the at least one of the media content and the application is equal to or less than the set risk tolerance;
notifying, at the server, the parent account of the received selection of the at least one of the media content and the application from the child account; and
transmitting, from the server, the approved selected at least one of the media content and the application to a device associated with the child account.

2. The method of claim 1, wherein when the identified risk basis value of the at least one of the media content and the application is less than or equal to the set risk tolerance, the selected at least one of the media content and the application is auto-approved by the parent account.

3. The method of claim 2, wherein the selected at least one of the media content and the application is auto-approved based on at least one from the group consisting of: a cost of the selected at least one of the media content and the application is less than a threshold cost, an educational value of the selected at least one of the media content and the application, and an available allowance is equal to or greater than the cost of the selected at least one of the media content and the application.

4. The method of claim 1, wherein the notifying the parent account occurs when the identified risk basis value of the selected at least one of the media content and the application is greater than a threshold value.

5. The method of claim 1, wherein the notifying the parent account occurs according to at least one of the group consisting of: when a cost of the selected at least one of the media content and the application exceeds a pre-set threshold, when an age range of the selected at least one of the media content and the application exceeds a pre-set threshold, and when the selected at least one of the media content and the application is non-educational.

6. The method of claim 1, wherein the identifying the risk basis value is determined according to at least one from the group consisting of: a type of the selected at least one of the media content and the application, a rating of the selected at least one of the media content and the application, an educational value of the selected at least one of the media content and the application, a frequency of purchases that include the selected at least one of the media content and the application, a cost of the selected at least one of the media content and the application, an educational grade level, a genre of the selected at least one of the media content and the application, and an available allowance amount.

7. The method of claim 1, wherein the approving further comprises receiving approval, at the server, from the parent account after the notifying.

8. The method of claim 1, further comprising:
transmitting payment information from the linked parent account to the server when the selected at least one of the media content and the application is approved and has a cost.

9. The method of claim 8, further comprising:
determining whether there is an available allowance for the child account that is linked to the parent account; and
deducting the cost of the selected at least one of the media content and the application from the available allowance when the cost is less than or equal to the available allowance.

10. A system comprising:
a first device that is associated with a child account;
a second device that is associated with a parent account, wherein the parent account includes payment information; and
a server to link the child account to the parent account in a memory device of the server, set a risk tolerance in the memory device of the server for at least one of a media content and an application selected via the child account according to input received from the parent account of the second device, to receive a selection for at least one of a media content and an application via the child account, identify a risk basis value of the selected at least one of the media content and the application for the child account, approve the selected at least one of the media content and the application for the child account when the identified risk basis value of the at least one of the media content and the application is equal to or less than the set risk tolerance, notify the parent account of the received selection of at least one of the media content and the application from the child account, and transmit the approved selected at least one of the media content and the application to the first device.

11. The system of claim 10, wherein when the identified risk basis value of the at least one of the media content and the application is less than or equal to the set risk tolerance, the selected at least one of the media content and the application is auto-approved by the parent account of the second device.

12. The system of claim 12, wherein the selected at least one of the media content and the application is auto-approved based on at least one from the group consisting of: a cost of the selected at least one of the media content and the application is less than a threshold cost, an educational value of the selected at least one of the media content and the application, and an available allowance is equal to or greater than the cost of the selected at least one of the media content and the application.

13. The system of claim 10, wherein the server notifies the second device associated with the parent account when the identified risk basis value of the selected at least one of the media content and the application is greater than a threshold value.

14. The system of claim 10, wherein the server notifies the second device associated with the parent account according to at least one of the group consisting of: when a cost of the selected at least one of the media content and the application exceeds a pre-set threshold, when an age range of the selected at least one of the media content and the application exceeds a pre-set threshold, and when the selected at least one of the media content and the application is non-educational.

15. The system of claim 10, wherein the server determines the risk basis value according to at least one from the group consisting of: a type of the selected at least one of the media content and the application, a rating of the selected at least one the media content and the application, an educational value of the selected at least one of the media content and the application, a frequency of purchases that include the selected at least one of the media content and the application, a cost of the selected at least one of the media content and the application, an educational grade level, a genre of the selected at least one of the media content and the application, and an available allowance amount.

16. The system of claim 10, wherein the server receives approval from the second device that is associated with the parent account after the notification is transmitted to the second device.

17. The system of claim 10, wherein the second device transmits payment information from the linked parent account to the server when the selected at least one of the media content and the application is approved and has a cost.

18. The system of claim 17, wherein the server determines whether there is an available allowance for the child account that is linked to the parent account and deducts the cost of the selected at least one of the media content and the application from the available allowance when the cost is less than or equal to the available allowance.
